(19) United States
(12) Patent Application Publication
(10) Pub. No.: US 2002/0106073 A1
(43) Pub. Date: Aug. 8, 2002

(54) Audio telephone dialer for telephone number selected on display in any software application

(76) Inventor: Peter S. Tevlin, Houston, TX (US)

Correspondence Address: CONLEY ROSE & TAYON, P.C., P. O. BOX 3267, HOUSTON, TX, 77253-3267, US

(21) Appl. No.: 09/776,309

(22) Filed: Feb. 2, 2001

(51) Int. Cl. H04M 1/00; H04M 3/00

(52) U.S. Cl. 379/354; 379/355.01

(57) ABSTRACT

A method and system for dialing a telephone number selected on display in a software application includes a computer system chassis and a display device coupled to the computer system chassis. A mouse, stylus, or keyboard selection keys allow a computer user to select a telephone number on display in the software application. One or more audio speakers in the computer chassis or connected to the monitor generate Dual Tone Multi-Frequency (“DTMF”) audio tones. The audio system also includes an audio receiver that may be part of a telephone handset and receives the DTMF audio tones produced by the audio speakers. Prior to generation of the DTMF audio tones, the caller places the audio speakers in close proximity to the audio receiver of the telephone handset.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to a system that stores and displays the telephone numbers of an intended call recipient and which can also dial a stored telephone number. More particularly, the invention relates to a system and method to create audible dialing tones on a speaker to facilitate dialing of telephone numbers. Still more particularly, the present invention relates to a computer system that allows a caller to utilize the audio capability of the computer system to quickly, securely and accurately dial a series of numbers to make voice telephone calls.

2. Background of the Invention

The ability to organize and quickly retrieve information is becoming an increasingly important attribute. It has become commonplace to juggle numerous work and family responsibilities involving meetings and telephone calls at preset times and places. Organizing such information prior to the advent of computer organizers involved using a paper organizer to note the date and time of the meeting or telephone call and the address or telephone number. Especially in the case of telephone numbers, a mistake in transcription could lead to serious problems contacting the proper party.

Computer desktops, notebooks, personal device assistants (“PDAs”) referred to herein as “organizers,” allow individuals to quickly and accurately store the address and phone numbers of contacts. One example of a PDA is the Compaq IPAQ®. Electronic planners in the organizer may then cross-reference meeting times and dates with the appropriate contact information stored in a centralized database on the planner. The ability to seamlessly store and organize information electronically has had a profound impact on the manner in which people organize their daily affairs, and for many, have replaced conventional paper planners and calendars.

Although telephone numbers may be accurately stored in the computer organizer, the user in most instances still is required to perform manual telephone dialing using the stored telephone number. Manual telephone dialing is cumbersome, slow, not secure, and potentially inaccurate. Furthermore, an automated method to dial telephone numbers without wired connections between the computer and telephone does not exist presently.

It would be advantageous if a simple system could be implemented that utilizes the audio capability of a computer to quickly, securely and accurately dial a series of numbers to make voice calls. It would also be advantageous if such a system allowed the user to select or highlight a series of numbers and/or characters on a computer display for dialing and in addition did not require wired connections between the computer and telephone to dial the telephone number. Despite the apparent advantages of such a system, to date no such system has been implemented.

### SUMMARY OF THE INVENTION

The problems noted above are solved in large part by a computer system for dialing a telephone number displayed on a computer display device. The computer system preferably includes a display device coupled to the computer system. A mouse, stylus, or selection keys on a keyboard allow a computer user to select a sequence of numbers displayed on the display device. The sequence of numbers can be a telephone number or may be a userid and password for accessing email on a remotely located computer system. One or more audio speakers coupled to the computer system generate Dual Tone Multi-Frequency (“DTMF”) audio tones. The computer system includes a sound board to generate the DTMF tones. The sound board contains an encoder/decoder and amplifier. The computer system also has an audio subsystem that contains an audio receiver. The audio receiver may be part of a telephone handset and receives the DTMF audio tones produced by the audio speakers.

Dialing a telephone number requires that the caller select a sequence of numbers displayed by a software application executing on the computer system. Next, the caller places the telephone handset, which includes an audio microphone, in close proximity to the audio speaker coupled to the computer system. The caller activates a dialing function with the sequence of numbers selected. The dialing function can recognize the selected telephone number as having an area code requiring long distance dialing and automatically insert the additional tones and pauses for dialing the long distance telephone number. Next, the computer system generates Dual Tone MultiFrequency (“DTMF”) audio signals for the sequence of numbers selected and transmits the DTMF audio signals to the audio speaker that produces DTMF audio tones. Finally, the caller places the telephone handset to his ear and conducts a telephone conversation.

### BRIEF DESCRIPTION OF THE DRAWINGS

For a detailed description of the preferred embodiments of the invention, reference will now be made to the accompanying drawings in which:

FIG. 1 shows in accordance with the preferred embodiment of the invention the operation of the audio telephone dialer for a selected telephone number; and

FIG. 2 shows the frequencies of the Dual Tone Multi-Frequency (“DTMF”) audio signals corresponding to a particular number or character in accordance with the preferred embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

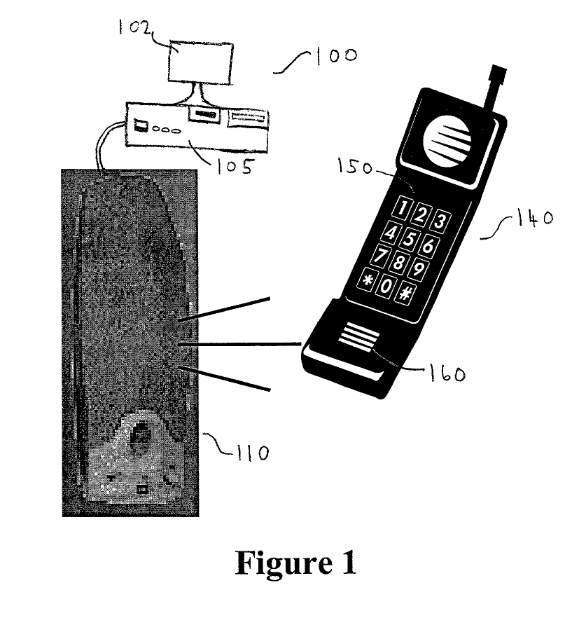

Referring now to FIG. 1, computer system 100 in accordance with the preferred embodiment comprises a display 102, speaker 110 that generates sound, and a telephone handset 140, including a telephone keypad 150 and microphone receiver 160. Computer system 100 may a desktop or laptop system such as the Compaq Presario® or Compaq Armada® or a personal device assistant (“PDA”) such as Compaq IPAQ®.

Display 102 in computer system 100 may comprise a cathode ray tube (“CRT”) display, a liquid crystal display (“LCD”) or any other type of display technology. Computer system 100 in conjunction with the display 102 must be able to provide the capability to select (or highlight) a series of numbers and/or characters on the display. Selection or highlighting of a series of numbers and/or characters on the display can be done using a mouse, stylus, trackball, flying erase head, selection keys on the keyboard (none of which are shown in FIG. 1) or any number of other devices to move a display pointer to select the desired numbers or characters. After selection of the numbers or characters, the dialing function of the preferred embodiment of the invention can be performed by the computer user pressing a mouse button to activate a display menu item while the display pointer is placed over the selected numbers or characters, by pressing a combination of keyboard keys, by pressing a button specially designed for dialing such as “Dial It!” on a modified keyboard or mouse, or by a voice command such as “Dial It.” The computer can be instructed to perform the dialing function while executing any software application containing the characters or numbers to be dialed as long as the numbers or characters have been selected.

Speaker 110 may be external to computer system 100 as shown in the preferred embodiment of FIG. 1 or alternatively may be incorporated in the computer system chassis 105 or computer system display 102. The speaker may be any audio speaker capable of reproducing multifrequency tones from approximately 750 Hz to 2500 Hz. Computer chassis 105 of computer system 100 houses the hardware (not shown in FIG. 1) that is capable of generating the DTMF tones of the preferred embodiment of the invention. In one preferred embodiment, a CreativeLabs SoundBlaster™ sound board is used to generate the DTMF tones. The present invention is not limited to the use of sound boards and may be implemented using modem hardware to generate the DTMF tones. Preferably, the sound board or other DTMF tone generation hardware includes a encoder/decoder and amplifier that couples to the speaker 110 for tone generation. The encoder/decoder preferably also includes hardware such as a notch filter that only permits the tone frequencies to pass while eliminating ambient noise.

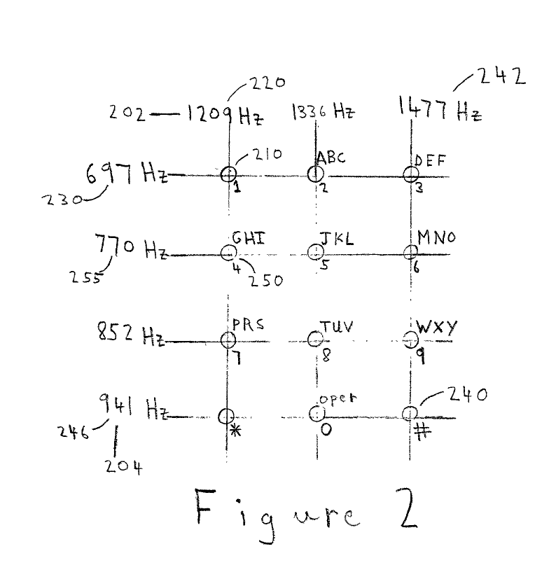

FIG. 1 also shows a telephone handset 140 including a telephone keypad 150 and microphone receiver 160. In one preferred embodiment of the invention telephone handset 140 does not include a telephone keypad 150. In accordance with the embodiment shown in FIG. 1, telephone keypad 150 is preferably able to generate DTMF tones as described in greater detail below with reference to FIG. 2 and includes an encoder/decoder sound generator.

Computer system 100, speaker 110 and telephone handset 140 in combination allow a caller to perform audio telephone dialing for a telephone number selected on display in any software application. Thus, the combination shown in FIG. 1 is a one-way computer to telephone connection to dial telephone numbers without a modem or wire connection. Software of the preferred embodiment that emulates a modem can interpret the dial signals from terminal programs (i.e., programs that transmit data to modems and receive data from modems), convert the signals to DTMF tones and drive speaker 110.

Turning now to FIG. 2, the frequencies, labeled 202 and 204, corresponding to each number or character in a telephone pad for generating DTMF tones is shown. Generation of DTMF tones is described in detail in “Understanding Telephone Electronics” by Stephen J. Bigelow, Howard W. Sams & Co. Publishing, February 1997. The signal generated by a DTMF encoder as shown in FIG. 2 is a sununation of the amplitudes of two sine waves of different frequencies. Thus, pressing the “1” button 210 on telephone keypad 150 will send a tone by adding 1209 Hertz tone 220 and 697 Hertz tone 230 to the other end of the line and pressing the “#” (octothorpe or pound symbol) button 240 will send a tone generated by adding 1477 Hertz tone 242 and 941 Hertz tone 246. Preferably, the tones used for each number or character use pairs of frequencies to represent the various keys. There is a “low frequency” tone 204 and a “high frequency” tone 202 associated with each button “0” through “9”, plus “*” (star) and “#”. The low frequency tones vary according to what horizontal row the button is in, while the high frequency tones correspond to the vertical column of the button. Thus, like the examples given above, when the “4” button 250 is pressed, the 1209 Hertz 220 and 770 Hertz 255 tones are sent together down the telephone line to the telephone central office that will then decode the number or symbol from this pair of tones.

The tone frequencies shown in FIG. 2 are selected to avoid harmonic frequencies (i.e., frequencies generated that are multiples of the tone frequencies) and other problems that could arise when two tones are sent and received over a telephone line. Preferably, the high frequency tone should be at least as loud and preferably louder than the low frequency tone. The high frequency tone may be as much as 4 decibels louder than the low frequency tone.

As described above, DTMF tones preferably can be generated by a sound card, integrated circuits for encoding such as Crystal Semiconductor Corp. CS20x family or Motorola MC145436, and microcontrollers such as Motorla MC68HC05F5 with built in encoder. Digital signal processors (“DSPs”) such as Texas Instruments TMS 320 also permit encoding of DTMF tones. Decoding of DTMF tones can similarly be performed by use of the same devices described above. Another method of decoding includes using a tuned filter combination capable of detecting each tone using detection circuits.

Use of the DTMF tone generation hardware and software in accordance with FIG. 1 and FIG. 2 in the preferred embodiment contemplates having the caller hold the microphone end of a telephone handset near the computer speaker as shown in FIG. 1, highlight the number on computer display 102 to be called, and then activate the dialing function of the preferred embodiment. Automated computer dialing of the voice telephone call would then commence. After completion of the dialing, the caller could remove the handset from the speaker area and conduct a normal telephone conversation.

Preferably, the software application to perform the dialing function described is capable of recognizing when the designated dialing activation event has occurred, capture the numbers or other characters selected on the display 102, convert them into the DTMF tones needed to dial a telephone and then annunciate these tones on the computer's speaker 110. The software application is also able to allow entry and storage of local area codes and long distance dialing numbers and authorization codes. Finally, the software application of the preferred embodiment can recognize the selected number as having an area code requiring long distance dialing and automatically insert the additional tones and pauses for dialing the long distance number.

The software application to perform dialing of the preferred embodiment can be implemented as a Windows™ operating system application using a programming language such as C or C++. In an alternative embodiment, a Basic Input Output Subsystem (“BIOS”) application using assembly language can be implemented. BIOS implementations of the software application to perform dialing are preferred for use across computer systems executing any number of different operating systems such as Linux™ or Windows™.

The DTMF tone generation hardware and software of the preferred embodiment permits a caller to perform telephone dialing for selected telephone numbers. A computer system with the embodiment of the invention could quickly and accurately replace the manual task of dialing telephones. A caller using the preferred embodiment of the invention can make telephone calls from their home phone, office phone, pay phone, cell phone or their hotel room phone without using paper or paper organizers to keep phone numbers. One advantage of such a system mentioned above is that upon the user highlighting a seven digit phone number, the software dialing application of the preferred embodiment could automatically append long distance area codes and dial long distance calling card authorization strings along with the seven digit phone number. Owners of preexisting computer systems with the DTMF sound generation hardware in place but without the necessary software of the preferred embodiment of the invention could download and install the software.

Under one embodiment of the invention for dialing a phone number on a computer display, any of the nine numbers or characters shown in FIG. 2 can be sent to the software application for generation of DTMF tones. Any device on the other end of the telephone line that is able to understand DTMF tones can perform a function specified by the DTMF tones. Thus, for example, if the device at the other end of the telephone line is another computer system, the DTMF tone sequence may be a request to read out any new email messages for a particular email account and include a userid and password. Another example preferably is the use of DTMF tone generation to simulate DTMF tones for bank-by-phone services (i.e., “Press 1 to access account information”).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system for dialing a telephone number, comprising:
a computer system;
a display device coupled to said computer system, wherein said computer system includes an input device that enables a user to select a sequence of numbers displayed on the display device;
an audio speaker, included in said computer system, said audio speaker generating Dual Tone Multi-Frequency (“DTMF”) audio tones;
a telephone device that includes an audio receiver that is capable of receiving said DTMF audio tones; and
wherein said computer user places the audio receiver in close proximity to the audio speaker and activates a dialing function to generate DTMF tones for the selected sequence of numbers.

2. The system of claim 1 wherein said computer user, upon completion of DTMF tone generation, conducts a telephone conversation using the audio receiver.

3. The system of claim 1 wherein said computer system chassis further comprises hardware to generate DTMF tones, said hardware including a sound board.

4. The system of claim 3 wherein said sound board couples to the audio speaker and includes an encoder/decoder and amplifier.

5. The system of claim 1 wherein said input device comprises a mouse pointing device.

6. The system of claim 1 wherein said input device comprises selection keys on a computer keyboard.

7. The system of claim 1 wherein said user selected sequence of numbers is a telephone number.

8. The system of claim 7 wherein the dialing function to generate DTMF tones can recognize the selected telephone number as having an area code requiring long distance dialing and automatically insert the additional tones and pauses for dialing the long distance telephone number.

9. A method of dialing a telephone number, comprising:
selecting, using an input device, a sequence of numbers displayed on a display device;
placing an audio receiver coupled to a telephone device in close proximity to an audio speaker coupled to the computer system;
activating a dialing function;
generating electronic signals for the sequence of numbers selected;
transmitting electronic signals to an audio speaker to produce Dual Tone Multi-Frequency (“DTMF”) audio tones; and
conducting a telephone conversation using the audio receiver after production of DTMF audio tones.

10. A method as in claim 9 wherein said computer system contains a sound board that generates the electronic signals, said electronic signals conforming to a DTMF format.

11. A method as in claim 10 wherein said sound board couples to the audio speaker and includes an encoder/decoder and amplifier.

12. A method as in claim 9 wherein said input device comprises a mouse pointing device.

13. A method as in claim 9 wherein said input device comprises selection keys on a computer keyboard.

14. A method as in claim 9 wherein the sequence of numbers selected is a telephone number.

15. A method as in claim 14 wherein the dialing function can recognize the selected telephone number as having an area code requiring long distance dialing and automatically insert the additional tones and pauses for dialing the long distance telephone number.

16. A method of dialing a telephone number, comprising:
selecting a sequence of numbers displayed in a software application executing on a computer system;
placing an audio receiver coupled to a telephone device in close proximity to an audio speaker coupled to the computer system;
activating a dialing function with the sequence of numbers selected;
generating Dual Tone Multi-Frequency (“DTMF”) signals for the sequence of numbers selected;
transmitting DTMF signals to an audio speaker to produce DTMF audio tones; and
communicating with a remote object over a telephone line using the audio receiver after production of DTMF audio tones.
